(19) United States
(12) Patent Application Publication
(10) Pub. No.: US 2007/0258233 A1
(43) Pub. Date: Nov. 8, 2007

(54) Single piece dual coating reflector recessed wall wash luminaire

(75) Inventor: Allan Gray, Anaheim, CA (US)

Correspondence Address: Thomas Elam;Allan Gray, 2861 E. La Palma Avenue, Anaheim, CA, 92806, US

(73) Assignee: Intense Lighting, LLC, Anaheim, CA (US)

(21) Appl. No.: 11/381,639

(22) Filed: May 4, 2006

(51) Int. Cl. F21S 8/00

(52) U.S. Cl. 362/148

(57) ABSTRACT

A recessed ceiling mounted luminaire with a single piece, dual finish coating reflector designed to evenly illuminate vertical surfaces without the use of a lens medium, such as interiors walls of a building, utilizing vertical lamp sources mounted on a common down light frame and giving a common down light exterior visual appearance from the space below. Current art utilized modified downlight reflectors with an additional kicker reflector added to redirect only a portion of available light accordingly. This invention combines lessons learned by previous art with the ability to complete the task by using a single reflector design with added efficiency. This adds advantages not previously seen in this area of expertise including higher energy efficiency with better uniformity on all areas of the vertical surfaces.

### TECHNICAL FIELD OF THE INVENTION

A lighting system for illuminating vertical surfaces in building interiors.

### BACKGROUND OF THE INVENTION

In the field of lighting, wall washing or the art of illuminating a vertical surface is common, but is often difficult to achieve proper results. Instruments of illumination have been developed and used to accomplish this task for many decades. Some have achieved satisfactory results of the illumination task, but fail to blend architecturally into the overall desires of the space.

It is recognized by persons skilled in the art that applying proper illumination to vertical surfaces of a space such as walls of a corridor or small room can visually extend the perceived distance to that surface, thus creating the illusion of greater area within the space. Common areas of this exercise are conference rooms, corridors, offices, living spaces, or other locations where the perception of size is desired.

In this exercise, people skilled in the art of lighting design prefer a device that will evenly illuminate a great portion of the vertical surface or wall quietly as to allow the occupants of the space to enjoy the desired results without drawing attention to the actual task.

It is also recognized by persons skilled in the art of lighting design that vertical illumination can be used to draw attention to objects either mounted to a vertical surface or located directly in front of that surface so that persons within that space may more noticeably recognize or view that object.

There is a plurality of instruments of shapes, sizes, and mountings that have been used by persons skilled in the art to accomplish the illumination task of wall washing. To categorize these devices, there are devices that are unique in appearance to the lay person that are specifically installed in a space to perform the task of wall washing and those devices that are designed to disguise themselves matching other luminaries in the space so that the lay person does not recognize the device.

Instruments that are unique often have the advantage of providing a superior illumination quality. These instruments may be surface mounted or suspended in the area or recessed in the ceiling with large housings sometimes in continuous rows. These devices may use visual reflectors, lenses, baffles, or other equipment to focus lighting on the surface.

Instruments designed to disguise themselves are much harder to develop, often less efficient and much harder to achieve proper results, but have the ability to perform their task without the lay person recognize them. This method is preferred by those skilled in the art of lighting as well as interior space design. There is less clutter and more uniformity in the appearance of the space. It is in this category the invention is applied.

There is a plurality of prior art in this category having the wall wash luminaire resemble closely that of a standard down light used for general illumination within the same space. All prior art has been developed in much the same way throughout the years. Developers start with a standard recessed down light with a symmetrical reflector designed to direct light straight down from the ceiling to the floor in a symmetrical pattern. They modify this optical system to take portions of the symmetrical illumination and redirect to the vertical surface adjacent to the location. Common methods in the past were to insert a scoop reflector or cup inside the standard down light reflector. Over time this method was seen as too inefficient and could be seen by the lay person as a different device, undesired by persons skilled in the art.

In the late 1980's product developers used the common method found today of cutting portions of the symmetrical reflector perpendicular to the vertical surface to be illuminated and inserting a second reflector specifically designed to take a portion of the symmetrical illumination and redirect towards the surface. This created more of an asymmetric reflector system.

There are pluralities of asymmetric designed reflectors using a modified standard downlight with special angled reflectors or reflectors with special facets cut or bent to optically direct the light. Prior patent issued to Ling, U.S. Pat. No. 5,535,110 disclose the use of multiple facets designed into the separate bottom reflector insert to redirect a portion of the light to the wall surface in a uniform manner, in addition to continuing to provide light direct below the mounting. This device relies on the upper portion of the reflector gathering and directing light down onto the separate attached secondary reflector. Prior patent issued to Leadford, U.S. Pat. No. 5,800,050 discloses a method of again gathering light from the lamp in an upper portion of the primary reflector and directing a portion to a special separate attached outer reflector located towards the bottom of the fixture redirecting the light to the vertical surface or wall, in addition to continuing to provide light direct below the mounting. Prior patent issued to Sherman, U. S. Pat. No. 6,350,047 discloses a downlight wall wash fixture and the method of assembly using two separate reflectors mounted together to achieve the both down lighting and wall washing.

Prior patent issued to Rippel, U.S. Pat. No. 6,632,006 B1 discloses the use of an offset vertical lamp similar to the present invention. In lieu of using a dual coated reflector to properly distribute light, the prior invention relies on a single coat, or finished internal reflector and the use of a lens medium to redirect the direction of the light towards the wall.

The commonality of these inventions are the reflectors are collectively designed for dual function of lighting the area directly below the fixture, as well as the vertical surface adjacent to where the fixture is mounted. These modifications to a standard reflector to distribute light straight down means only a small portion of light is actually distributed to the vertical surface.

Additional prior patents similar to Neil, U.S. Pat. No. 6,994,456 use offset lamping to redirect light, but are not symmetrical and therefore do not resemble other standard symmetrical down lights within the same area.

This invention differs from prior art in several ways. The reflector or optical system was created to illuminate vertical surfaces as its first and primary task. Although the bottom portion, visible to the lay person is identical in appearance to a common down light, the reflector recessed above the ceiling is uniquely designed and not a modified down light reflector. The unique characteristics are as follows: (1) the lamp socket assembly is offset from the center of the reflector located as far from the vertical surface as the mounting will allow. This allows the optically designed reflector to distribute as much light to the vertical surface with more uniformity and with greater brightness closer to the ceiling line of the vertical surface without the use of a lens medium. (2) The reflector has a dual internal finish for optical control of the overall brightness. The portion of the reflector furthest from the lamp and closest to the vertical surface has a matte or dull finish to minimize brightness visible to people behind the mounting. This 180 degree area of the reflector minimizes glare or flash to people in close proximity to the device. This allows the device to be effectively used to illuminate the vertical surface and not add discomfort to the occupants of the space achieving the quiet performance those skilled in the art of lighting and interior design prefer. (3) The lamp socket assembly is adjustable to allow field adjustment by those skilled in the art of installation. This adds not only efficiency to the system, but allows the device to perform at its best regardless of uncontrollable problems in mounting locations or spacing.

The preferred embodiment of this invention commonly uses a plurality of compact fluorescent lamps. A special socket unique to this invention was developed to lock the fluorescent lamp in its proper position. This insures the proper optical control and most efficient use of energy required to perform the task. The invention could achieve similar effectiveness with a plurality of other lamp sources such as Light Emitting Diodes (LED), Incandescent, High Intensity Discharge (HID), or other sources designed to be mounted in the vertical position. The socket assemble may be different depending on the lamp source, but the theory of optical design would be similar to all.

Other advantages to the reflector design have been discovered as beneficial. The offset position of the lamp allows for added space to adequately remove or insert a new lamp by person skilled in the art. This minimizes finger prints on the reflector allowing for a more efficiency throughout the life of the system.

The unique reflector mounts in a standard recessed frame and uses a standard trim ring that provides a finish to the ceiling opening. People skilled in the art of installation will find this an advantage as these components match those of a standard recessed down lights.

### SUMMARY OF THE INVENTION

The invention provides vertical illumination or wall washing adjacent to its recessed mounting, preferred in the ceiling; with proper set back distances from the vertical surface or wall and may match the exposed appearance to other common recessed down lights within the same environment. The optical design utilizes a unique single piece cone shape reflector, design with dual internal finishes or coatings, a lamp socket assembly offset from center with the lamp in the vertical position in the preferred embodiment, and the socket in the upper position to achieve superior illumination qualities of uniformity, while additionally providing improved energy efficiency over other prior art.

The single piece reflector has dual finish coatings divided in two (2) one hundred and eighty (180) degree internal areas specifically located in regards to the lamp to perform functions required by this system. The specular or highly reflective area of the reflector, with its mid point directly behind the center of the lamp extending ninety (90) degrees in each direction, provides direction of light at maximum efficiency towards the vertical surfaces adjacent to its mounting increasing the performance of the system. The diffused or matte area of the reflector, is opposite that of the specular area, provides brightness control and minimizes flash or cone brightness at the uncomfortable and visible high angles to persons within the space below.

The inventor's recognize there may be situations where the proportions of the dual coat finishes may not each be one hundred and eighty (180) degrees as the preferred embodiment to accomplish unusual illumination situations.

One example of a unique situation may occur with a structural column within the environment where the physical width may require a narrower distribution of light from the reflector and increased brightness control for persons within the space. This may be accomplished by decreasing the width of the specular portion of the reflector and increasing the width of the matte area. Another example occurs where two (2) adjacent walls intersect and it is desired to light each wall, including the corner intersection uniformly. This may be accomplished by increasing the width of the specular portion and decreasing the matte area within the reflector. It is recognized that having either finish narrower than ninety (90) degrees or more than two hundred seventy (270) degrees minimizes the effectiveness of this invention.

The position of the lamp is offset from the center of the reflector purposely positioned to achieve optimal performance of the lamp source and to enable best use of highly specular portion of the reflector. This creates superior efficiency as compared to a centered lamp utilized by prior art and allows wider light distribution which provides better uniformity. The offset lamp position provides illumination spread much higher and lower on the vertical surface than centered lamp systems in prior art to provide not only a more uniform light distribution but also higher levels of illumination. In addition, the offset position of the lamp provides better shielding of the lamp source and thus achieves superior visual comfort. The lamp socket assembly is field adjustable to provide “fine-tuning” by persons skilled in the art of installation. In addition, the offset lamp placement allows for easier maintenance and less chance of breaking the lamp, as well as allows for easier orientation of the fixture as offset side is always positioned away from the vertical surface to be illuminated.

The inventor recognizes the preferred embodiment of this invention utilizes a lamp source in the vertical position. Due primarily to a space mounting restriction it may be necessary to use the lamp source in the horizontal position. An acceptable performance loss would be associated with this positioning, but the overall reduction in height of approximately twenty-five (25%) percent would allow a common style system to be used in multiple areas of the space where a reduced mounting area occurs. The socket assembly would be located in a similar location in the reflector as the preferred embodiment, but would be rotated ninety (90) degrees in the upper portion of the dual finished reflector.

The reflector is attached to a single frame separate from the attached ballast or transformer and electrical junction box. The frame shall be installed by those skilled in the art, secured to the building structure, as well as the building electrical system. This installation is well known to those skilled in the art and would not required unique instructions other than the proper positioning of the dual finished reflector.

### BRIEF DESCRIPTION OF THE DRAWINGS

FIG. 1 is a perspective view of one embodiment of a recessed wall washer as it would appear pre-installation. A shadowed view showing a fluorescent lamp position can be seen and embodiment is shown with optional adjustable support brackets.

FIG. 2 is a cross-sectional view of the preferred embodiment allowing more components to be seen and explained.

FIG. 3 is a perspective view of the preferred embodiment to show a typical installation and how unit is positioned in relationship to the vertical surface to be illuminated and the distribution ethics of the embodiment's optical system.

FIG. 4 is an exploded perspective view of the preferred embodiment to show greater detail of the reflector and socket assembly.

FIG. 5 is an top view cross-section of the preferred embodiment reflector to show greater detail the lamp position and the position of the two (2) different internal reflector coatings in relationship to the vertical surface to be illuminated and the location of the lamp.

FIG. 6 is a cross-section of the preferred embodiment reflector to show greater detail the lamp position and the position of the two (2) different internal reflector coatings in relationship to the location of the lamp.

### DESCRIPTION OF THE PREFERRED EMBODIMENTS

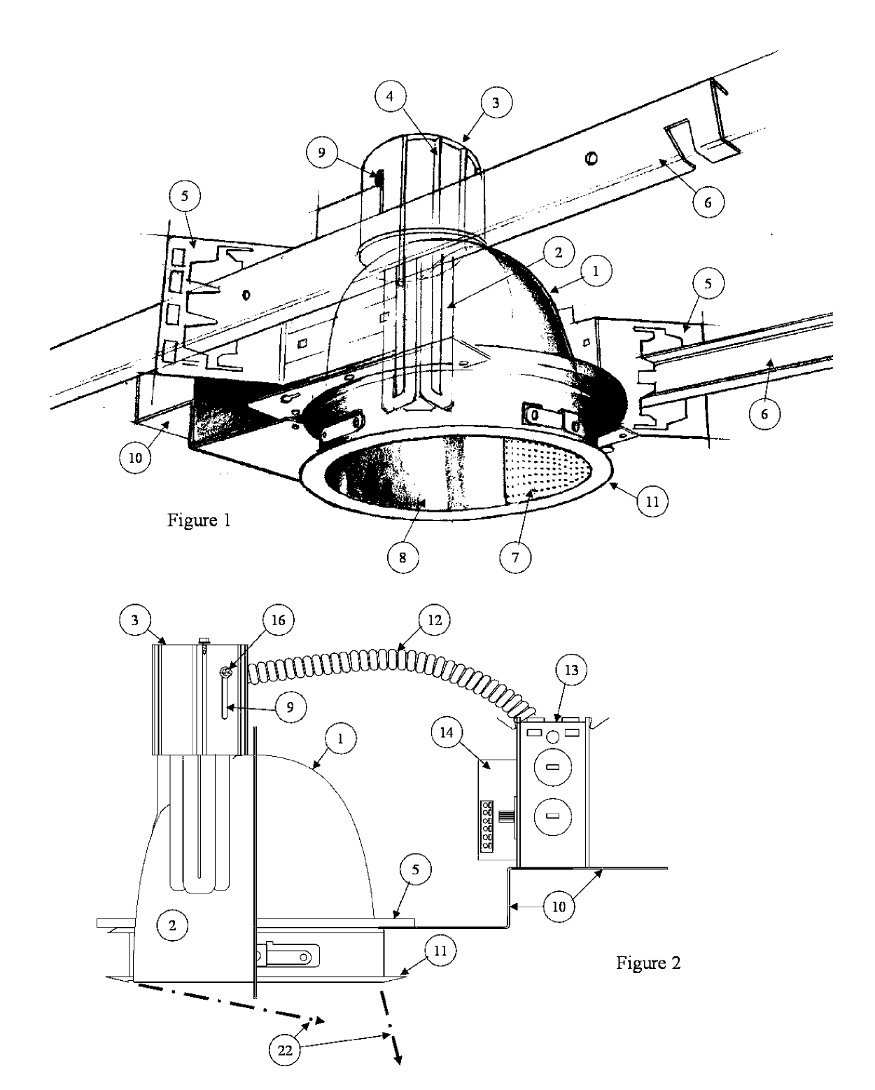

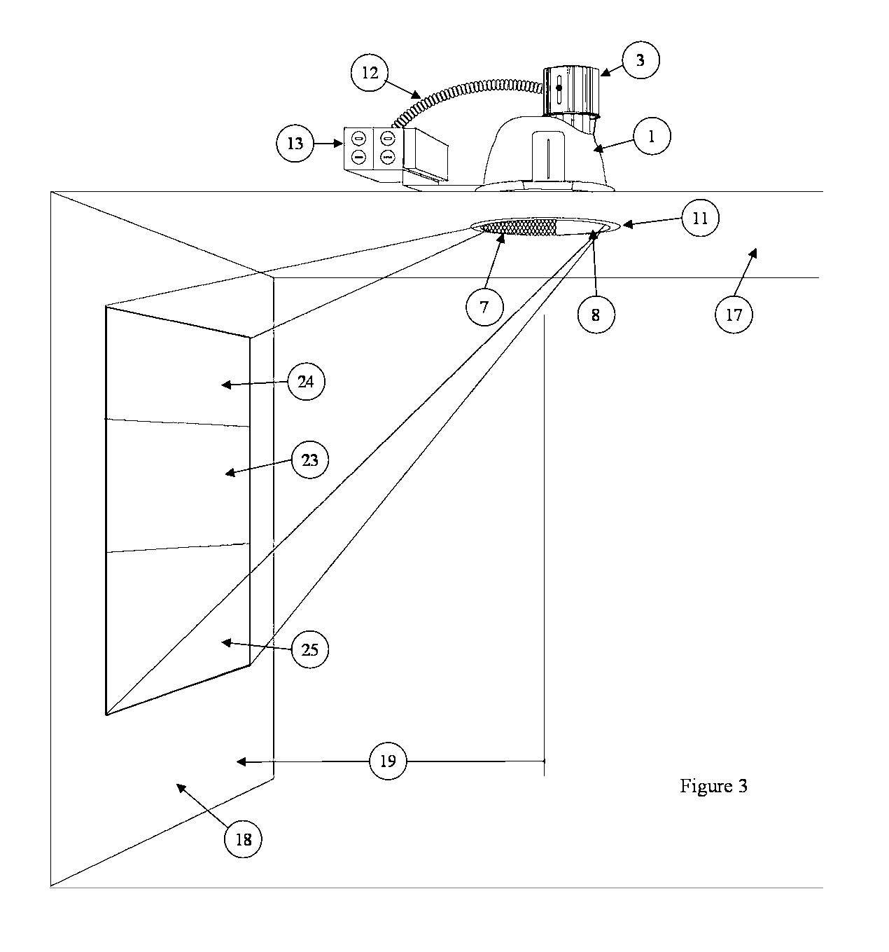

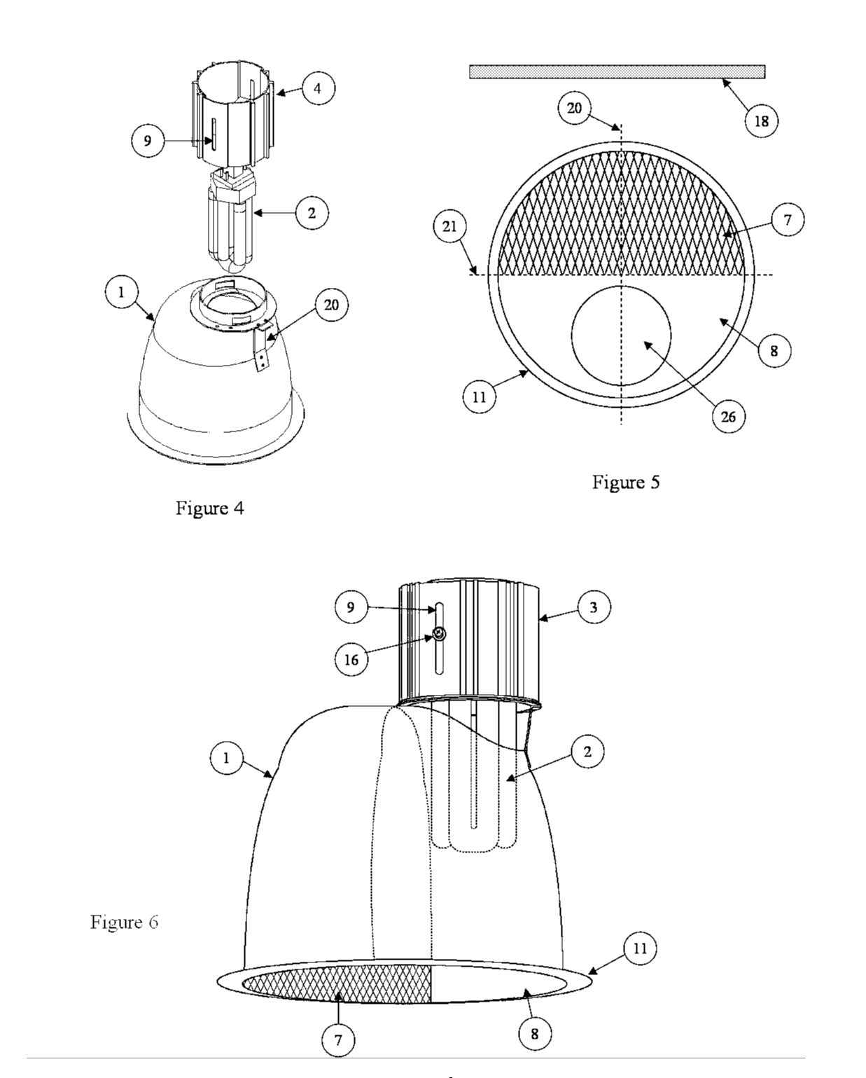

FIG. 1, the wall washer fixture is shown as it would appear prior to installation as people skilled in the art would receive it from the manufacture. The preferred embodiment shown is designed for a vertically mounted fluorescent lamp 2 positioned in the one-piece reflector 1. Other lamp sources may be used to achieve similar characteristics mounted in the same location and in the same fashion. The separate lamp socket assembly 3 is attached to the one-piece reflector 1 by use of tool-less fasteners (FIG. 4-20). The lamp socket is made from light weight metal or other man-made material and designed with heat fins 4 to dissipate heat generated by the lamp source 2. A slide mount adjustment 9 allows the lamp to positioned higher or lower by those skilled in the art during installation per manufacturers instructions. The reflector 1, lamp source 2, and lamp socket assembly 3 are secured to a support frame or chassis 10 and held in place by fasteners. The reflector 1 and lamp source 2 are removed to facilitate installation of the fixture by those skilled in the arts. This is achieved by detaching the lamp socket assembly 3 from the reflector 1 and pulling with sufficient force to detach. Once frame 10 is installed and electrically connected to the building structure the reflector 1 and lamp source 2 are reassembled by reverse action with both components requiring reinsertion through the opposite side of the ceiling system (FIG. 3-17). The frame 10 is supported by those skilled in the art to the structure in an approved manner. Optional adjustable brackets 5 and bar hangers 6 may be used to facilitate the proper support required by building codes. The one-piece reflector 1 is cone shaped with the lamp source 2 offset from the center position of the cone. This can be seen in greater detail on FIG. 2. There are two (2) distinctive internal finishes. A dull or matte finish 7 is positioned closes to the vertical surface to be illuminated. The specular or shiny finish 8 is positioned furthest from the vertical surface to be illuminated. Persons skilled in the art shall properly position the cone 2 per manufacturers instructions. The ceiling opening cut by persons skilled in the art per manufacturers instructions is finished by the provided trim ring 11 located at the bottom of the reflector 2. This portion of the installation instructions is common to those skilled in the art and further explanation should not be required.

FIG. 2 shows greater clarity the offset position of the lamp source 2 in relation to the cone shaped reflector 1 as well as other components hidden from view in FIG. 1. Mounted to the frame 10 are the electrical junction box 13 as well as electrical components needed for the lamp source 2 such as a ballast or transformer 14. These components containing proper wiring provided and installed at the manufacturing facility prior to shipment are connected to the lamp socket assembly 3 by a flexible conduit 12, a common electrical component to the industry. This conventional connection procedure is well recognized in the field and needs no further explanation. The lamp source 2 is adjusted up or down by use of the slide mount adjustment 9 during installation by those skilled in the art by following manufacturers instructions and secured into position by provided screw 16. As previously mentioned the reflector 1 and lamp source 2 are detached from the lamp socket assembly 3 during installation. The reflector 1 is held in place upon completion of installation by a pressure ring 15 located on the frame 10. The arrows 22 indicate an approximate illumination angle in this embodiment and direction of the illumination concentration targeted towards an adjacent vertical surface such as an interior wall.

In FIG. 3 the preferred embodiment is shown in pictorial format, not to scale, in a mounting configuration to illuminate a vertical surface or wall 18. The location or setback 19 from the wall 18 is determined by manufacturer's recommendation and field conditions by those skilled in the art. The determining factors shall be the desired results knowing that the primary distribution of optical distribution created by the reflector 1 with the dual finished interior, half from a specular or highly reflective coating 8 and from a matte or diffused coating 7 shall be as follows. The maximum brightness will be angled at the lowest one-third of the total illumination output 25, the next amount of brightness angled at the center 23 of the total illumination output and the least amount of brightness will be angled at the upper one-third of the total illumination output 24. Position of the embodiment by those skilled in the art may be varied with the preferred with the electrical junction box 13 closes to the wall 18 with the flexible conduit 12 connecting to the lamp socket assembly 3 attached during installation to the one-piece reflector 1. The ceiling 17 opening, field cut by those skilled in the art, shall be finished cosmetically by a furnished trim ring 11 or optional flanged trim formed as a part of the reflector 1.

FIG. 4 shows greater clarity of the offset lamp source 2 position in relation to the cone shaped reflector 1. The lamp socket assembly 3 is attached to the reflector 1 by tool-free fasteners 20. The lamp source 2 inserts into the lamp socket assembly 3 and adjusted to proper height by persons skilled in the arts using the slide mount adjustment 9 to the recommended setting by the manufacturers instructions. Heat fins 4 are designed into the socket assembly 3 to dissipate the heat generated by the lamp source 2.

FIG. 5 shows greater clarity the position of the offset lamp 26 position in relationship to the center of the reflector 1. The lamp location 26 is centered in the reflector 1 perpendicular to the vertical surface to be illuminated 18 below the ceiling line as indicated by center line 20. The lamp location 26 is below the center line 21 of the reflector 1 parallel to the vertical surface 18 to be illuminated below the ceiling line locating the lamp source 2 at the furthest point away. The center line 21 parallel to the vertical surface 18 is also the division of the dual internal reflector 1 coatings in this embodiment. The reflector area with a matte or diffused finish 7 is positioned closer to the vertical surface 18 while the area of the reflector 8 closest to the lamp position 26 is of a highly reflective or specular finish. The finish trim ring 11 is shown in this view for clarification purposes.

FIG. 6, this cross-section shows in greater clarity the reflector 1 shape and the relationship of the lamp 2 position within. The lamp 2 is inserted into the lamp socket assembly 3 by those skilled in the art during installation and later may be changed by lay persons familiar with the process. During installation the lamp 2 position shall be adjusted by those skilled in the art based upon manufacture's recommendations and field visual sighting by using the slide mount adjustment feature 9 of this embodiment to be secured by the provided pressure locking screw 16. This adjustment feature will raise or lower the targeted angle of brightness to conform with final desired illumination quality. This allows for a plurality of lamp sizes and types to used within the same basic embodiment.

While the invention has been particularly shown and described with respect to preferred embodiments, it will be readily understood that minor changes in the details of the invention may be made without departing from the spirit of the invention. Having described the invention, we claim:

What is claimed is:

1. A recessed wall washer luminaire assembly installable in an accessible ceiling into a mounting frame common to the industry having a bottom light exit aperture comprising:
a. A single piece reflector with dual finishes divided in two (2) one hundred and eighty (180) degree internal areas with the highly reflective area of the reflector, with its mid point directly behind the center of the lamp extending ninety (90) degrees in each direction, the second less reflective area opposite the highly reflective area and:
b. An adjustable lamp socket assembly for at least one vertically mounted compact fluorescent lamp offset from the center point of the upper portion of the reflector with the socket in the upper most position.

2. A recessed wall washer luminaire assembly installable in an accessible ceiling into a mounting frame in claim 1 with High Intensity Discharged lamp adjustable socket, in lieu of fluorescent.

3. A recessed wall washer luminaire assembly installable in an accessible ceiling into a mounting frame in claim 1 with a Light Emitting Diode (LED) lamp adjustable socket, in lieu of fluorescent.

4. A recessed wall washer luminaire assembly installable in an accessible ceiling into a mounting frame in claim 1 with an incandescent lamp adjustable socket, in lieu of fluorescent.

5. A recessed wall washer luminaire assembly installable in an accessible ceiling into a mounting frame in claim 1 with a plurality of internal colored finishes.

6. A recessed wall washer luminaire assembly installable in an accessible ceiling into a standard mounting frame in claim 1 where the single piece reflector with dual finishes are divided into internal areas not equal to one hundred and eighty (180) degrees, but neither portion of finishes exceeding two hundred seventy (270) degrees.

7. A recessed wall washer luminaire assembly installable in an accessible ceiling into a mounting frame in claim 1 where the lamp source is mounted horizontal in lieu of vertical.

8. A recessed wall washer luminaire assembly installable in an accessible ceiling into a mounting frame in claim 1 where the single piece reflector with dual finishes are divided into internal areas not equal to one hundred and eighty (180) degrees, but neither portion of finishes exceeding two hundred seventy (270) degrees.

9. A method for using a recessed wall washer luminaire assembly installable in a non-accessible ceiling into a mounting frame common to the industry having a bottom light exit aperture comprising:
a. A single piece reflector with dual finishes divided in two (2) one hundred and eighty (180) degree internal areas with the highly reflective area of the reflector, with its mid point directly behind the center of the lamp extending ninety (90) degrees in each direction, the second less reflective area opposite the highly reflective area and:
b. An adjustable lamp socket assembly for at least one vertically mounted compact fluorescent lamp offset from the center point of the upper portion of the reflector with the socket in the upper most position.

10. A method for using a recessed wall washer luminaire assembly installable in a non-accessible ceiling into a mounting frame in claim 9 with High Intensity Discharged lamp adjustable socket, in lieu of fluorescent.

11. A method for using a recessed wall washer luminaire assembly installable in a non-accessible ceiling into a mounting frame in claim 9 with a Light Emitting Diode (LED) lamp adjustable socket, in lieu of fluorescent.

12. A method for using a recessed wall washer luminaire assembly installable in a non-accessible ceiling into a mounting frame in claim 9 with an incandescent lamp adjustable socket, in lieu of fluorescent.

13. A method for using a recessed wall washer luminaire assembly installable in a non-accessible ceiling into a mounting frame in claim 9 with a plurality of internal colored finishes.

14. A recessed wall washer luminaire assembly installable in a non-accessible ceiling into a mounting frame in claim 9 where the lamp source is mounted horizontal in lieu of vertical.

15. A recessed wall washer luminaire assembly installable in a non-accessible ceiling into a mounting frame in claim 9 where the single piece reflector with dual finishes are divided into internal areas not equal to one hundred and eighty (180) degrees, but neither portion of finishes exceeding two hundred seventy (270) degrees.
